(19) United States
(12) Patent Application Publication
(10) Pub. No.: US 2010/0312696 A1
(43) Pub. Date: Dec. 9, 2010

(54) VIRTUAL SHARED ACCOUNT

(76) Inventors: Parijat Sinha, San Jose, CA (US); Nitin Kulshrestha, Menlo Park, CA (US)

Correspondence Address: HAYNES AND BOONE, LLP;IP Section, 2323 Victory Avenue, Suite 700, Dallas, TX, 75219, US

(21) Appl. No.: 12/477,881

(22) Filed: Jun. 3, 2009

(51) Int. Cl. G06Q 40/00

(52) U.S. Cl. 705/40; 705/42

(57) ABSTRACT

Methods and systems according to one or more embodiments are provided for establishing and managing a virtual shared account. According to an embodiment, a method for a virtual shared account comprises setting up an n-member virtual shared account for achieving a goal over a network; adding members to the virtual shared account and contributing funds to the virtual shared account. The method may also comprise achieving the goal of the virtual shared account, and once the goal of the virtual account is achieved, the virtual shared account may be closed.

### BACKGROUND

1. Technical Field

Embodiments of the present disclosure generally relate to financial transactions, and more particularly, to methods and systems for virtual shared accounts between a group of members or users.

2. Related Art

Routinely, one or two individuals may establish a general joint account in a financial institution from which funds may be used for general purposes. For example, joint accounts may be used as needed by one or two individual partners in a business or personal relationship.

In electronic commerce, users may use various funding sources such as credit cards to purchase and pay for products and/or services from online merchants over communication networks, such as the Internet. In this regard, individual customers may frequently engage in transactions with a variety of merchants through, for example, various merchant websites. However, typical ways of making payments over the Internet may be cumbersome and inconvenient if a group of users desires -to make purchases in connection with a group activity to meet a particular goal as no joint or shared accounts may be available in the e-commerce context. Currently, for example, if a group of users desires to purchase a product or service online in order to meet a particular goal, one of the users may have to use his or her own individual account to pay for the product or service on behalf of the group of users or members, and then collect appropriate reimbursement from each of the other users or members of the group. To address potential problems with current group situations such as this, there is a need for virtual shared accounts that may be used by a group of users or members in the e-commerce context.

### SUMMARY

As will be further described herein in relation to various embodiments, methods and systems for establishing and managing a virtual shared account are provided wherein a group of users is allowed to contribute funds to a shared account in order to meet a goal. Once the goal is met, the virtual shared account may be closed.

In accordance with an embodiment of the disclosure, a method for a virtual shared account includes: setting up an n-member virtual shared account for achieving a goal over a network; adding members to the virtual shared account; and contributing funds to the virtual shared account.

In accordance with another embodiment of the disclosure, a client device includes one or more processors and one or more memories adapted to store a plurality of machine-readable instructions. When executed by the one or more processors, the machine-readable instructions are adapted to cause the client device to set up an n-member virtual shared account for achieving a goal over a network; invite members to join the virtual shared account; and contribute funds to the virtual shared account to achieve the goal of the virtual shared account.

In accordance with another embodiment of the disclosure, a system for setting up and using a virtual shared account includes a payment service provider in communication with at least one user device over a network. The system also includes one or more processors and one or more memories adapted to store a plurality of machine-readable instructions. When executed by the one or more processors, the machine-readable instructions are adapted to cause the system to: create an n-member virtual shared account for achieving a goal over the network; add members that join the virtual shared account; maintain and manage funds of the virtual shared account; and facilitate payment using the funds of the virtual shared account when the goal of the virtual shared account is achieved.

These and other features and advantages of the embodiments of the present disclosure will be more readily apparent from the detailed description of the embodiments set forth below taken in conjunction with the accompanying drawings.

### BRIEF DESCRIPTION OF THE FIGURES

FIG. 1 illustrates a flow chart for a virtual shared account according to an embodiment of the present disclosure.

FIG. 2 illustrates an example of a screenshot related to a virtual shared account on a user device according to an embodiment of the present disclosure.

FIG. 3 illustrates a diagram for setting up an n-user shared account according to an embodiment of the present disclosure.

FIG. 4 illustrates an example of a screenshot for creating a virtual shared account according to an embodiment of the present disclosure.

FIG. 5 illustrates an example of a screenshot when a virtual shared account is created according to an embodiment of the present disclosure.

FIG. 6 illustrates a flowchart for adding users to a virtual shared account according to an embodiment of the present disclosure.

FIG. 7 illustrates a diagram for contributing funds to a virtual shared account according to an embodiment of the present disclosure.

FIG. 8 illustrates a diagram for achieving a goal of a virtual shared account according to an embodiment of the present disclosure.

FIG. 9 illustrates a diagram for closing a virtual shared account according to an embodiment of the present disclosure.

FIG. 10 illustrates a block diagram of a payment system using a payment service provider according to an embodiment of the present disclosure.

FIG. 11 illustrates a block diagram of a system for implementing a device according to one embodiment of the present disclosure.

Like element numbers in different figures represent the same or similar elements.

### DETAILED DESCRIPTION

In accordance with various embodiments described herein, methods and systems are provided that enable a group of users to establish a virtual shared account that allows the group of users to contribute money or funds to the virtual shared account for a desired goal, for example, to purchase and pay for a particular item, product and/or service, to make a donation to charity, to pay for a social subscription, etc. Unlike a typical joint account that is often shared by just one or at most two accounts, the virtual shared account according to one or more embodiments of the present disclosure may be shared by many accounts and may be established for a particular goal rather than being a perpetual account. Once the particular goal is achieved, the virtual shared account may be closed as there may be no further need for the group to be involved in that virtual shared account. Thus, the virtual shared account is flexible in that it may be created based on a particular need to achieve a goal and may quickly be removed or closed when the particular goal has been achieved.

In order to set forth the privileges and obligations of the different members or users of the virtual shared account, a Management Contract may be provided.

According to an embodiment, the group of members or users may set up and use the virtual shared account through a payment service provider. The payment service provider may be, for example, PayPal and/or eBay of San Jose, Calif.

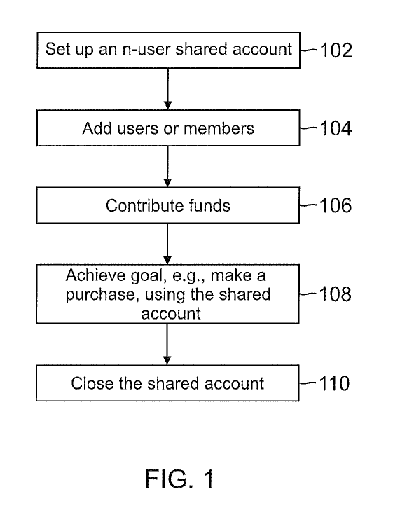

Referring now to the drawings wherein the showings are for purposes of illustrating embodiments of the present disclosure only, and not for purposes of limiting the same, FIG. 1 illustrates a flow chart for a virtual shared account according to an embodiment of the present disclosure.

In block 102 of FIG. 1, a user, which may also be referred to as a “leader user,” may create and set up an n-user virtual shared account using for example, a payment application loaded on a user device by a payment service provider as will be described herein. In this case, “n” refers to a number of users or members that may join the virtual shared account. The virtual shared account may be set up with the purpose of achieving a goal, for example, to purchase and pay for a particular item, product and/or service, to make a donation to charity, to pay for a social subscription, etc. Specific examples of such goals may include a university club desiring to purchase a television set wherein users (e.g., members of the university club) contribute to the virtual shared account until an amount covering the cost of the television set is reached. Another specific example of a goal may be to pay for a social subscription to a publication such as a magazine wherein the subscription rate may be less expensive on a group basis than on an individual basis. Yet another specific example of a goal of the virtual shared account may be to donate a certain amount of money to a favorite charity. It should be understood that there may be a variety of goals or uses for the virtual shared account and it is up to the creativity of the users involved to determine the goals and uses of the virtual shared account.

In block 104, once a virtual shared account is set up, for example, by a leader user, additional users or members may be invited to join and may be added to the virtual shared account.

In block 106, each user or member of the virtual shared account may contribute money or funds to the virtual shared account. Privileges and obligations for each user with respect to the virtual shared account may be set forth in a Management Contract as will be described herein.

In block 108, when enough funds are contributed to the virtual shared account, the goal is achieved and, for example, a purchase or a donation may be made using the virtual shared account.

In block 110, once the goal is achieved, the virtual shared account may be closed automatically, or it may be closed by the leader user or another user or member as may be set forth, for example, in a Management Contract governing the virtual shared account.

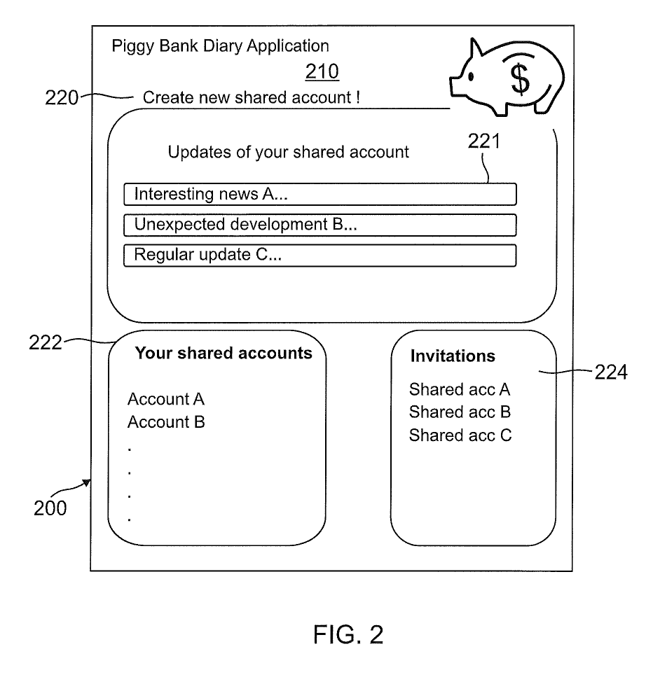

Referring now to FIG. 2, an example of a screenshot related to a virtual shared account on a user device is illustrated according to an embodiment of the present disclosure.

As illustrated in FIG. 2 according to an embodiment, an image of a user device, which in this embodiment is illustrated as a computer desktop 200, displays a window of a website 210, for example, a social networking website such as Facebook™ with a “Piggy Bank Diary Application” therein, which includes a “Create new shared account” operation 220, an “Updates of your shared account” window 221, a “Your shared accounts” window 222, and an “Invitations” window 224. It should be noted that although a “Piggy Bank Diary Application” on a social networking website is illustrated, various other applications and types of websites may be used according to various embodiments related to a virtual shared account.

Once a user logs in to, for example, the social networking website 210 having the Piggy Bank Diary Application, the user has several options including executing the “Create new shared account” operation 220 to create a new n-member virtual shared account. The user first creating the new virtual shared account may be designated as a “leader user.” As described above, the new virtual shared account may be set up for a specific goal, for example, to make a purchase, to donate to charity, to purchase a social subscription, etc.

Another option for the user may be to connect to the “Updates of your shared account” window 221, which allows the user to find information and keep updated on the latest happenings of the user's current shared accounts, for example, the user may get information on interesting news, unexpected developments or just get regular updates on an ongoing basis by simply executing the appropriate link.

The user also has an option to connect to the “Your shared accounts” window 222 to access details of each of the user's shared accounts. Additionally, the user may connect to the “Invitations” window 224 to review invitations for other shared accounts and to accept or reject such invitations.

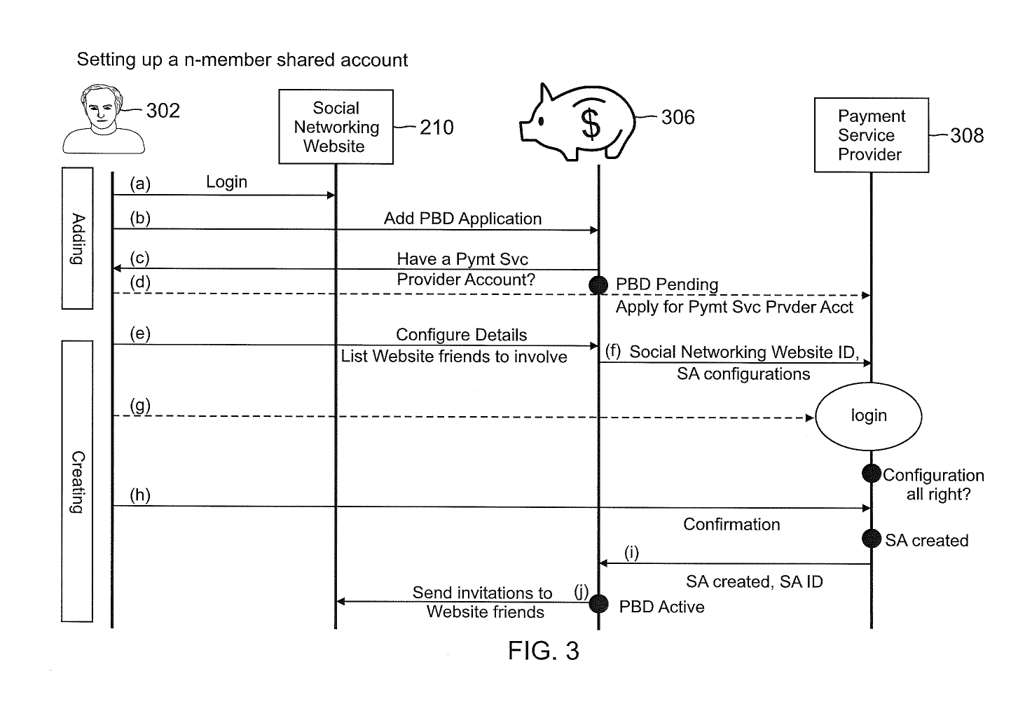

Referring now to FIG. 3, a diagram for setting up an n-user shared account is illustrated according to an embodiment of the present disclosure. The embodiment of FIG. 3 may be one implementation of block 102 of FIG. 1 according to an embodiment.

In line (a) of FIG. 3, a user 302 may log in to a website 210, for example, a social networking site such as Facebook™. In line (b), user 302 may add and view an application in the social networking website 210, for example, a piggy bank diary application 306 (hereinafter, “PBD Application 306”). It should be understood that the piggy bank diary application is used herein as an example, and various other applications may be used as appropriate for a particular networking website. Also, it should be understood that although embodiments described herein may refer to a social networking website to create and manage a virtual shared account, other types of websites including, for example, websites for online games, or other types of communications over a network may be used to create and manage the virtual shared account.

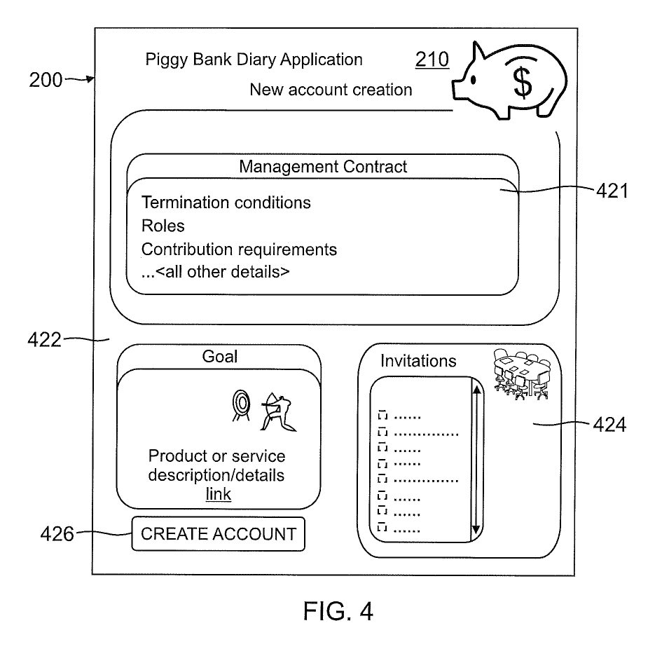

Next, in line (c), user 302 is asked if the user has an account with a payment service provider 308, for example, PayPal. Payment service provider 308 is capable of maintaining and managing a virtual shared account and includes funding information or resources therein. In line (d), if user 302 does not have an existing account with payment service provider 308, user 302 may apply for an account with payment service provider 308. Once user 302 has an account with payment service provider 308, user 302 may set up a virtual shared account, which involves certain tasks as will be described herein, for example, with respect to the embodiment illustrated in FIG. 4 below.

Next, in line (e) of FIG. 3, the details of the newly created virtual shared account are configured including, for example, listing the users to be invited such as friends from social networking website 210. In line (f), PBD Application 306 communicates the virtual shared account configuration details and the social networking website identification associated with user 302 to payment service provider 308. Payment service provider 308 may keep and manage the virtual shared account and related configuration details.

In line (g), user 302 may log in to his or her individual account with payment service provider 308 and in line (h), user 302 may review and confirm the configuration details of the new virtual shared account. If desired, user 302 may have the option to change the configuration details of the virtual shared account. By login into his or her individual account with payment service provider 308, the user may access, through his or her payment service provider 308 account, the virtual shared account. Login into the payment service provider 308 account may be done through a secure way; for example, user 302 may be required to enter credentials for authentication such as a PIN, username/password, etc.

In line (i), payment service provider 308 verifies to PBD Application 306 that a virtual shared account has been created and may provide identification information for the virtual shared account. In line (j), PBD Application 306 is active and may send invitations to other users including, for example, social networking website friends that may be interested in joining the virtual shared account.

Referring to FIG. 4, an example of a screenshot for creating a new virtual shared account is illustrated according to an embodiment of the present disclosure. As illustrated in FIG. 4 according to an embodiment, an image of a user device, which in this embodiment is illustrated as a computer desktop 200, displays a window of a website 210, for example, a social network website such as Facebook™, with a “Piggy Bank Diary Application” therein. To create a virtual shared account, user 302 may perform several tasks including: 1) setting up a Management Contract via Management Contract window 421; 2) setting goal(s) for the virtual shared account in Goal window 422; and 3) choosing other users or friends to invite to be members of the virtual shared account in window 424.

In Management Contract window 421, user 302 may set up a Management Contract that establishes the obligations and privileges of the users or members of the virtual shared account. For example, the Management Contract may set forth the termination conditions for the virtual shared account, a description of the roles of the users, the contribution requirements of the users as well as other appropriate terms and conditions.

In Goal window 422, goal(s) may be set for the virtual shared account. For example, the goal may be to purchase a product or service, to make a donation to charity or to pay for a social subscription. Conveniently, a link may be provided to direct the user to a description or details of the desired goal.

In Invitations window 424, other users are chosen to be invited as members of the virtual shared account. In an embodiment, in social networking website 210, members may be chosen from a list of existing friends found in the social networking website 210.

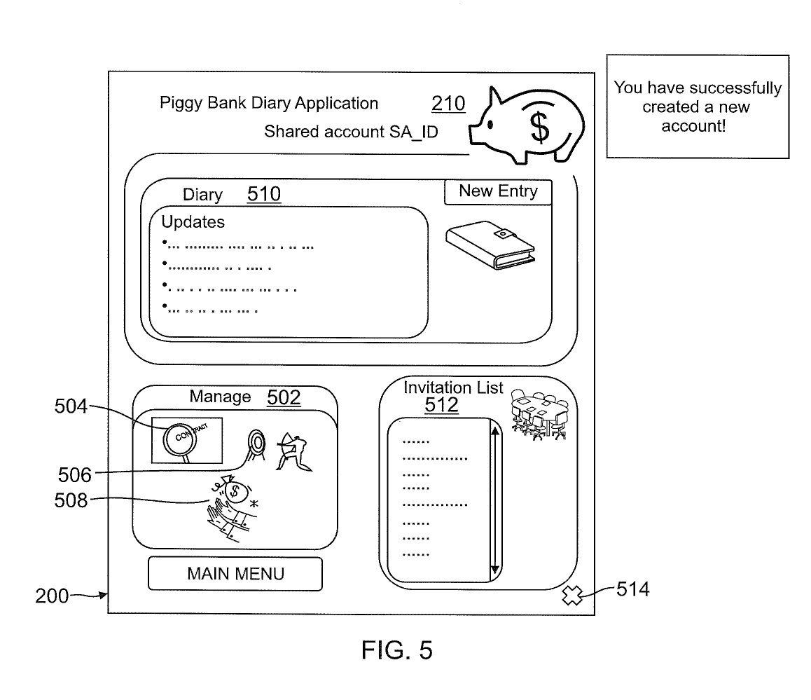

Referring to FIG. 5, an example of a screenshot when a virtual shared account is created is illustrated according to an embodiment of the present disclosure. Once the user (or leader user) has created a new virtual shared account that may be identified, for example with an identification provided by the payment service provider, the user may review and change the configuration details of the virtual shared account at any time or as provided in the Management Contract. In this embodiment, the user may manage the virtual shared account by accessing various windows that are available and displayed in the user device, which in this embodiment comprises a desktop 200, including a Manage window 502, a Diary window 510 and an Invitation list window 512.

In Manage window 502, the user may read in detail and edit or change the Management Contract by executing a Management Contract operation 504. Various terms and conditions governing the privileges and obligations of the users of the virtual shared account may be edited. The leader user that created the virtual shared account may be designated as the only user that may manage the virtual shared account and edit or change the configuration details of the virtual shared account. However, any other user, for example, a second leader user, may also be permitted to manage and edit or change the configuration details of the virtual shared account. Such designations and related terms and conditions may be provided in, for example, the Management Contract.

In Manage window 502, the user may also review and edit the goal(s) for the virtual shared account by executing a Goals operation 506. Goals may be edited to reflect, for example, a change in amount of money needed to achieve the goal, the type of product or service to be purchased, etc. Furthermore, in Manage window 502, the user may contribute money or funds to the virtual shared account by executing Funds operation 508.

In Diary window 510, the user may manage the virtual shared account with respect to maintaining a diary related to the virtual shared account and managing communications between the users or members of the virtual shared account. For example, updates related to the virtual shared account may be posted on a regular basis. It should be noted that according to one or more embodiments, communications between the users may be exclusively managed by and are the responsibility of the Piggy Bank Diary Application.

In Invitation List window 512, the user may invite other users to join the virtual shared account and/or may review the invitation list and the status of pending invitations.

The user may have an option to terminate a virtual shared account by executing operation 514.

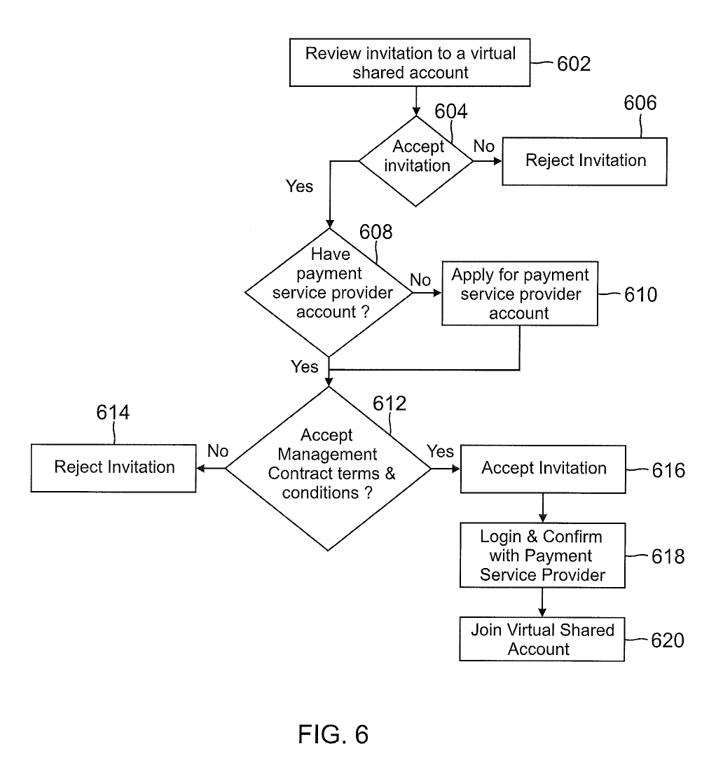

Referring to FIG. 6, a flowchart for adding users to a virtual shared account is provided according to an embodiment of the present disclosure. The embodiment of FIG. 6 may be one implementation of block 104 of FIG. 1 according to an embodiment.

In block 602, a user may receive and review an invitation to join a virtual shared account for a certain goal. As discussed above, for example, with respect to the embodiment of FIG. 3, in line (j) of FIG. 3, a leader user that has created a new virtual shared account may invite other users, for example, friends in a social networking website. An invitation may be sent to other users from an application on a social networking website, for example, a Piggy Bank Diary Application 306 as illustrated with respect to the embodiment of FIG. 3.

In block 604 of FIG. 6, the invited user decides whether to accept or reject the invitation to join a virtual shared account. In block 606, the invited user may simply decide to reject the invitation. On the other hand, in block 608, if the invited user decides to accept the invitation, the communication of the acceptance is made, for example, via PBD Application 306, which would then ask if the invited user has an account with a payment service provider.

In block 610, if the invited user does not have an account with a payment service provider, then the invited user may apply for such an account.

Once the invited user has a current account with the payment service provider, in block 612, the invited user reviews and decides whether to accept the terms and conditions set forth in the Management Contract governing the virtual shared account including termination conditions, roles of the users, contribution requirements, etc. In addition to the Management Contract, the invited user may also review a description of the goal(s), the list of other users that have been invited to be members of the virtual shared account, etc.

In block 614, if the invited user decides not to accept the terms and conditions of the Management Contract governing the virtual shared account, the invited user rejects the invitation.

On the other hand, in block 616, if the invited user decides to accept the terms and conditions of the Management Contract governing the virtual shared account, the invited user accepts the invitation. Upon acceptance of the invitation, PBD Application 306, for example, may communicate such information to the payment service provider and pass along the corresponding virtual shared account identification information and applicable social networking website identification information, for example.

In block 618, the invited user may log into his or her payment service provider account and confirm the acceptance of the invitation. This also connects the invited user's payment service provider account to the virtual shared account. Login to the payment service provider may be done in a secure manner, for example, through a User and Password or other credential so that the login information is not compromised.

In block 620, the invited user is confirmed and successfully joins as an active member of the virtual shared account. Optionally, once an invited member is confirmed and joins as an active member, a news feed may be sent to all members of the virtual shared account.

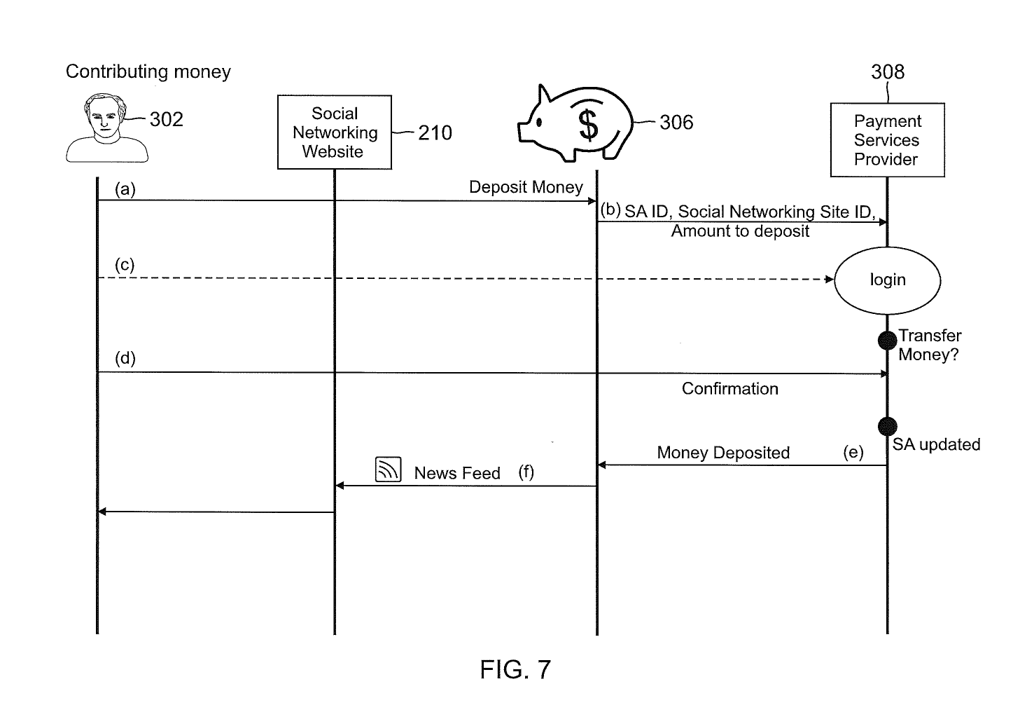

Referring to FIG. 7, a diagram for contributing funds to a virtual shared account is illustrated according to an embodiment of the present disclosure. The embodiment of FIG. 7 may be one implementation of block 106 of FIG. 1 according to an embodiment.

Once a user 302 has joined a virtual shared account on a payment service provider 308 using, for example, a PBD Application 306 on a social networking website 210, user 302 may decide to contribute funds to the virtual shared account.

In line (a) of FIG. 7, user or member 302 of the virtual shared account contributes or deposits money or funds to the virtual shared account maintained by payment service provider 308 by a communication through PBD Application 306.

In line (b), PBD Application 306 in turn communicates with payment service provider 308 setting forth the amount of funds or money to be deposited, along with identification information of the virtual shared account and identification of the social networking website. If for example, a credit card designated on the payment service provider 308 is to be charged, the corresponding amount of money is credited to the virtual shared account and debited to the designated credit card.

In line (c), user 302 may log into his or her payment service provider 308 account and in line (d) user 302 may provide confirmation to transfer money in the indicated amount to the virtual shared account. Payment service provider 308 updates the status of the virtual shared account accordingly.

In line (e), payment service provider 308 communicates to PBD Application 306 that funds or money in the indicated amount has been deposited into the virtual shared account as identified.

Optionally, in line (f) a news feed may be sent to all members of the virtual shared account reflecting the update to the money balance of the virtual shared account.

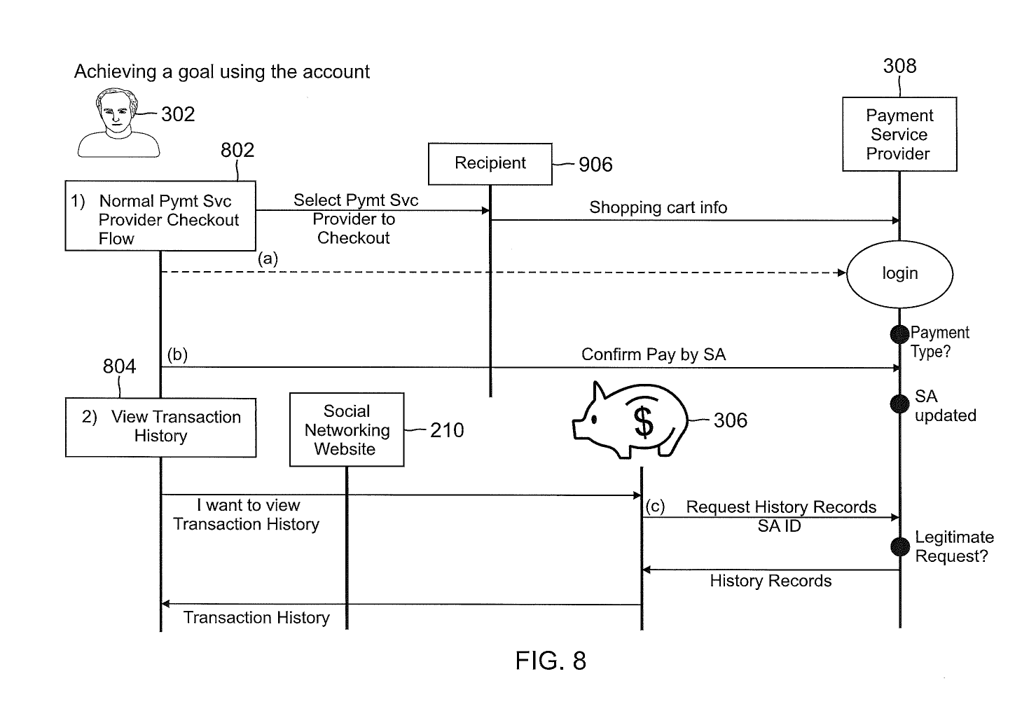

Referring to FIG. 8, a diagram for achieving a goal for a virtual shared account is illustrated according to an embodiment of the present disclosure. The embodiment of FIG. 8 may be one implementation of block 108 of FIG. 1 according to an embodiment.

When enough money or funds are contributed to the virtual shared account, a user 302, which may be a leader user or any other designated user as provided in the Management Contract, may proceed to purchase a product or service, or make a donation to a charity, or purchase a group subscription to a publication, etc. in order to achieve the goal of the virtual shared account.

User 302 may use a normal checkout flow 802 using a payment service provider 308 to check out and make payment when, for example, making a purchase, to achieve the goal of the virtual shared account. User 302 also has the option of viewing a transaction history 804.

In normal checkout flow 802, user 302 may select payment service provider 308 to checkout and make payment to a recipient 906 for achieving the goal of the virtual shared account. Examples of recipient 906 may include a charity or a business entity such as a merchant that sells products and/or services, or a marketplace wherein users may bid for products and/or services as may be described in a shopping cart's information.

In line (a), when user 302 logs into his or her payment service provider 308 account to check out, user 302 chooses the virtual shared account in the payment service provider account to make the payment. In line (b), the user may confirm the payment type, that is, that the appropriate virtual shared account is to be used for payment. At this point, the virtual shared account status is updated reflecting the amount of payment debited to the virtual shared account and credited to recipient 906.

User 302 may view a transaction history 804 of the virtual shared account using, for example, PBD Application 306 on social networking website 210.

In line (c), PBD Application 306 may ask payment service provider for transaction history records as requested by user 302 associated with identification information of a virtual shared account. The identification information of the virtual shared account may be established by service provider 308 and may be used for authentication and security purposes. Once payment service provider 308 verifies that the request is legitimate, payment service provider 308 provides the transaction history records to PBD Application 306, which in turn allows user 302 to access the PBD Application 306 on social networking website 210 to view the transaction history of the identified virtual shared account.

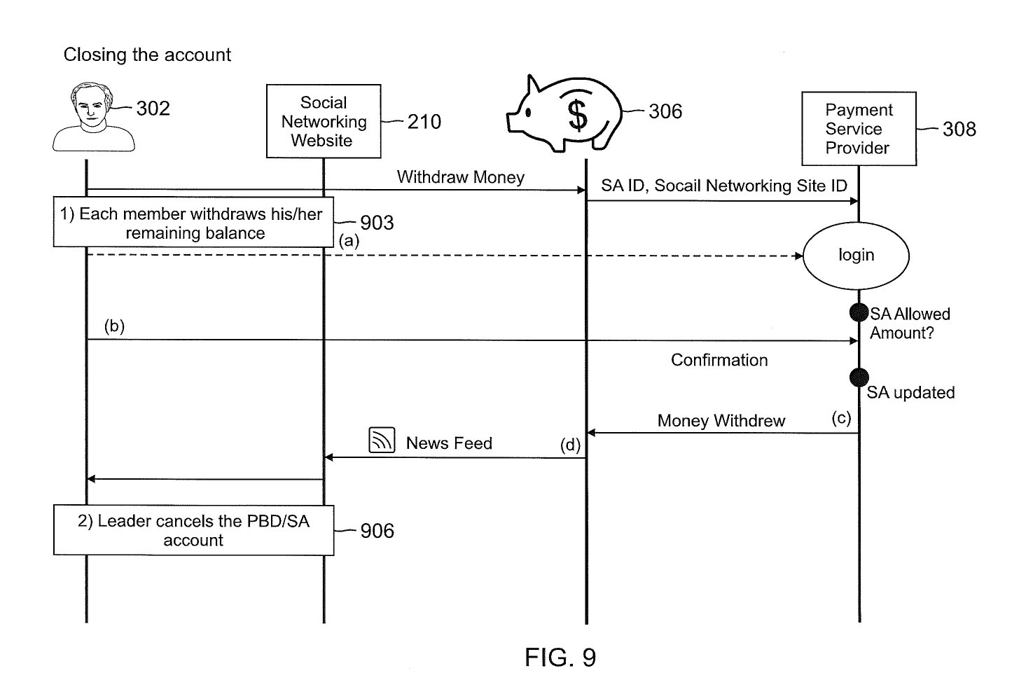

Referring to FIG. 9, a diagram for closing a virtual shared account is illustrated according to an embodiment of the present disclosure. The embodiment of FIG. 9 may be one implementation of block 110 of FIG. 1 according to an embodiment.

Once the goal of the virtual shared account is achieved, the virtual shared account may be closed automatically, or it may be closed by the leader user or another user or member as may be set forth, for example, in a Management Contract governing the virtual shared account.

In flow 903, each user or member of the virtual shared account may withdraw his or her remaining balance, if any, once the goal of the virtual shared account is achieved. This may be accomplished via PBD Application 306 on social networking website 210. PBD Application 306 may communicate to payment service provider 308 that user 302 is withdrawing money from a virtual shared account as identified by the virtual shared account identification information and the social networking website identification information.

In line (a) user 302 may log into his or her payment service provider 308 account. Payment service provider 308 verifies whether the amount requested to be withdrawn is allowed for the corresponding virtual shared account. If so, in line (b), user 302 confirms the withdrawal. Payment service provider 308 may then update the status of the virtual shared account reflecting the amount of the withdrawal and in line (c), may communicate to PBD Application 306 the money amount that has been withdrawn from the corresponding virtual shared account. Optionally, in line (d), once money has been withdrawn, PBD Application 306 may send a news feed via social networking website 210 to all members of the virtual shared account.

In flow 906, once all funds have been spent or withdrawn from the virtual shared account, user 302, which may be the leader user or another user as may be designated, for example, according to the Management Contract, may cancel or close the virtual shared account. Alternatively, once all funds have been spent or withdrawn from the virtual shared account, the virtual shared account may be closed automatically.

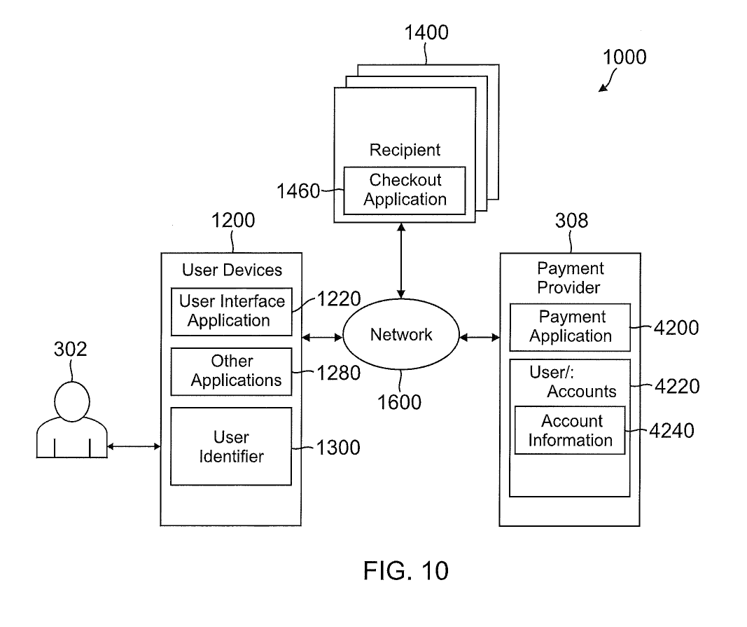

FIG. 10 illustrates a block diagram of a payment system using a payment service provider according to an embodiment of the present disclosure.

FIG. 10 shows one embodiment of a block diagram of a system 1000 adapted to facilitate payment transactions associated with a virtual shared account via a client device 1200 over a network 1600. As shown in FIG. 10, the system 1000 includes at least one user device 1200 (e.g., network computing device), one or more recipient devices 1400 (e.g., network server devices), and at least one payment service provider device 308 (e.g., network server device) in communication over the network 1600.

The network 1600, in one embodiment, may be implemented as a single network or a combination of multiple networks. For example, in various embodiments, the network 1600 may include the Internet and/or one or more intranets, landline networks, wireless networks, and/or other appropriate types of communication networks. In another example, the network 1600 may comprise a wireless telecommunications network (e.g., cellular phone network) adapted to communicate with other communication networks, such as the Internet. As such, in various embodiments, the user device 1200, recipient servers 1400, and payment service provider 308 may be associated with a particular link (e.g., a link, such as a URL (Uniform Resource Locator) to an IP (Internet Protocol) address).

The user device 1200, in various embodiments, may be implemented using any appropriate combination of hardware and/or software configured for wired and/or wireless communication over the network 1600. In various examples, the user device 1200 may be implemented as a wireless telephone (e.g., cellular or mobile phone), a personal digital assistant (PDA), a personal computer or desktop, a notebook computer, a television set, a game console, a DVR and/or various other generally known types of wired and/or wireless computing devices. It should be appreciated that the user device 1200 may be referred to as a client device or a customer device without departing from the scope of the present disclosure.

The user device 1200, in one embodiment, includes a user interface application 1220, which may be utilized by the user 302 to conduct financial transactions (e.g., shopping, purchasing, bidding, etc.) with the payment service provider server 308 over the network 1600. For example, the user interface application 1220 may be implemented as an item selection application to track, manage, and store information related to the purchase of items, products, and/or services over the network 1600. In one aspect, purchase expenses may be directly and/or automatically debited from an account related to the user 302 via the user interface application 1220.

In one implementation, the user interface application 1220 comprises a software program, such as a graphical user interface (GUI), executable by a processor that is configured to interface and communicate with the service provider server 308 via the network 1600. In another implementation, the user interface application 1220 comprises a browser module that provides a network interface to browse information available over the network 1600. For example, the user interface application 1220 may be implemented, in part, as a web browser to view information available over the network 1600. In another example, the user 302 is able to access recipient websites, such as merchant websites, via the one or more recipient servers 1400 to view and select, for example, applications, products, and/or services for purchase, and the user 302 is able to purchase applications, products, and/or services from the one or more recipient servers 1400 via the payment service provider server 308. Accordingly, the user 302 may conduct financial transactions (e.g., purchase and provide payment for applications, products, and/or services) from the one or more recipient servers 1400 via the payment service provider server 308.

The user device 1200, in various embodiments, may include other applications 1280 as may be desired in one or more embodiments of the present disclosure to provide additional features available to the user 302. In one example, such other applications 1280 may include security applications for implementing client-side security features, programmatic client applications for interfacing with appropriate application programming interfaces (APIs) over the network 1600, and/or various other types of generally known programs and/or software applications. In still other examples, the other applications 1280 may interface with the user interface application 1220 for improved efficiency and convenience.

According to an embodiment, the other applications 1280 include an application that may be loaded on user device 1200 by service provider 308. Such application enables user 302 to easily make payments for applications, products and/or services over user device 1200.

The user device 1200, in one embodiment, may include at least one user identifier 1300, which may be implemented, for example, as operating system registry entries, cookies associated with the user interface application 1220, identifiers associated with hardware of the user device 1200, or various other appropriate identifiers. The user identifier 1300 may include one or more attributes related to the user 302, such as personal information related to the user 302 (e.g., one or more user names, passwords, photograph images, biometric ids, addresses, phone numbers, etc.) and banking information or funding sources (e.g., one or more banking institutions, credit card issuers, user account numbers, security data and information, etc.). In various implementations, the user identifier 1300 may be passed with a user login request to the payment service provider 308 via the network 1600, and the user identifier 1300 may be used by the payment service provider 308 to associate the user 302 with a particular user account maintained by the payment service provider 308.

The one or more recipient servers 1400, in various embodiments, may be maintained by one or more business entities (e.g., merchant sites, resource information sites, utility sites, real estate management sites, social networking sites, charity sites, publications sites, etc.) offering various applications, products, and/or services for purchase and payment.

Each of the recipient servers 1400, in one embodiment, may include a marketplace application, which may be configured to provide information over the network 1600 to the user interface application 1220 of the user device 1200. For example, the user 302 may interact with the marketplace application through the user interface application 1220 over the network 1600 to search and view various applications, products, and/or services available for purchase in a database maintained by a recipient.

Each of the recipient servers 1400, in one embodiment, may include a checkout application 1460, which may be configured to facilitate online financial transactions (e.g., purchase transactions) by the user 302 of applications, products, and/or services identified by the marketplace application. As such, in one aspect, the checkout application 1460 may be configured to accept payment information from the user 302 over the network 1600.

Each of the recipient servers 1400, in one embodiment, may include at least one recipient identifier, which may be included as part of the one or more applications, products, and/or services made available for purchase so that, e.g., particular applications, products, and/or services are associated with particular recipients. In one implementation, the recipient identifier may include one or more attributes and/or parameters related to the recipient, such as business and banking information. As described above, the user 302 may conduct financial transactions (e.g., selection, purchasing, and/or providing payment for applications, products, and/or services) with each recipient server 1400 via the service provider server 308 over the network 1600.

The payment service provider server 308, in one embodiment, may be maintained by a transaction processing entity, which may provide processing for online financial transactions and/or information transactions between the user 302 and one or more of the recipient servers 1400. As such, the payment service provider 308 includes a service application, which may be adapted to interact with each user device 1200 and/or each recipient server 1400 over the network 1600 to facilitate the selection, purchase, and/or payment of applications, products, and/or services by the user 302 from one or more of the recipient servers 1400. In one example, the payment service provider server 308 may be provided by PayPal, Inc. and/or eBay of San Jose, Calif., USA.

The service application, in one embodiment, utilizes a payment processing module to process purchases and/or payments for financial transactions between the user 302 and each of the recipient servers 1400. In one implementation, the payment processing module assists with resolving financial transactions through validation, delivery, and settlement. As such, the service application in conjunction with the payment processing module settles indebtedness between the user 302 and each of the recipient servers 1400, wherein accounts may be directly and/or automatically debited and/or credited of monetary funds in a manner as accepted by the banking industry.

The payment service provider 308, in one embodiment, may be configured to maintain one or more user accounts and recipient accounts in an account database 4220, each of which may include account information 4240 associated with one or more individual users (e.g., user 302) and recipients (e.g., one or more merchants associated with recipient servers 1400). For example, account information 4240 may include private financial information of each user 302 and each recipient associated with the one or more recipient servers 1400, such as one or more account numbers, passwords, credit card information, banking information, or other types of financial information, which may be used to facilitate online financial transactions between the user 302 and the one or more recipients associated with the recipient servers 1400. In various aspects, the methods and systems described herein may be modified to accommodate users and/or recipients that may or may not be associated with at least one existing user account and/or recipient account, respectively.

In one implementation, the user 302 may have identity attributes stored with the payment service provider server 308, and the user 302 may have credentials to authenticate or verify identity with the payment service provider server 308. User attributes may include personal information and banking information, as previously described. In various aspects, the user attributes may be passed to the payment service provider server 308 as part of a login, selection, purchase, and/or payment request, and the user attributes may be utilized by the payment service provider server 308 to associate the user 302 with one or more particular user accounts maintained by the payment service provider server 308.

The payment system described above with respect to the embodiment of FIG. 10 may be used to set up and facilitate payment in connection with virtual shared accounts according to one or more embodiments as described above.

Although various components and steps have been described herein as being associated with user device 1200, one or more recipient servers 1400, and payment service provider 308 of FIG. 10, it is contemplated that the various aspects of such servers illustrated in FIG. 10 may be distributed among a plurality of servers, devices, and/or other entities.

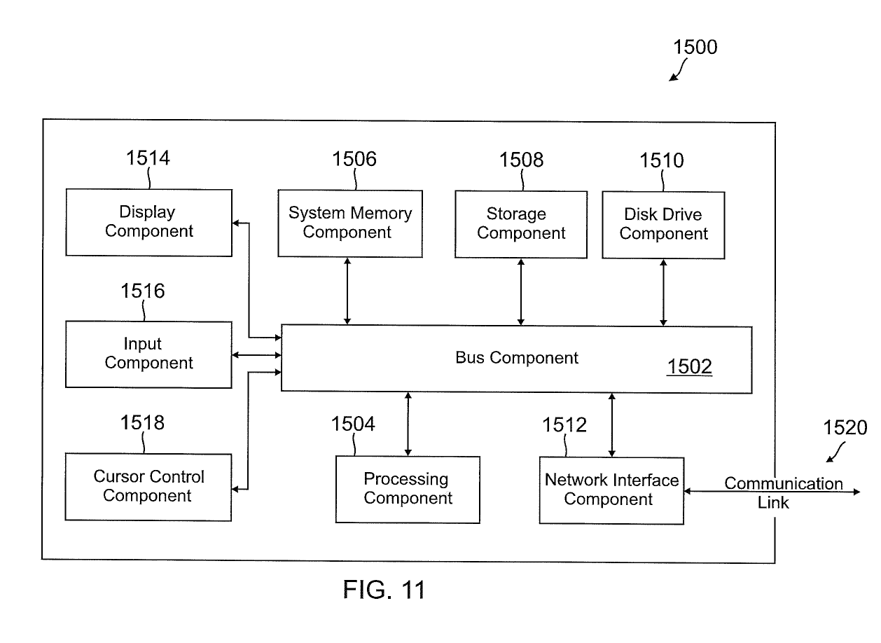

Referring now to FIG. 11 a block diagram of a system for implementing a device is illustrated according to one embodiment of the present disclosure.

FIG. 11 is a block diagram of a system 1500 suitable for implementing embodiments of the present disclosure, including user device 1200, one or more recipient servers or devices 1400, and payment service provider 180 server or device. System 1500, such as part of a cell phone, personal computer and/or a network server, includes a bus 1502 or other communication mechanism for communicating information, which interconnects subsystems and components, including one or more of a processing component 1504 (e.g., processor, micro-controller, digital signal processor (DSP), etc.), a system memory component 1506 (e.g., RAM), a static storage component 1508 (e.g., ROM), a network interface component 1512, a display component 1514 (or alternatively, an interface to an external display), an input component 1516 (e.g., keypad or keyboard), and a cursor control component 1518 (e.g., a mouse pad).

In accordance with embodiments of the present disclosure, system 1500 performs specific operations by processor 1504 executing one or more sequences of one or more instructions contained in system memory component 1506. Such instructions may be read into system memory component 1506 from another computer readable medium, such as static storage component 1508. These may include instructions to create accounts, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 1504 for execution. Such a medium may take many forms, including but not limited to, non-volatile media, volatile media, and transmission media. In various implementations, volatile media includes dynamic memory, such as system memory component 1506, and transmission media includes coaxial cables, copper wire, and fiber optics, including wires that comprise bus 1502. Memory may be used to store visual representations of the different options for payments or financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 1500. In various other embodiments, a plurality of systems 1500 coupled by communication link 1520 (e.g., network 1600 of FIG. 10, LAN, WLAN, PTSN, or various other wired or wireless networks) may perform instruction sequences to practice the disclosure in coordination with one another. Computer system 1500 may transmit and receive messages, data, information and instructions, including one or more programs (i.e., application code) through communication link 1520 and communication interface 1512. Received program code may be executed by processor 1504 as received and/or stored in disk drive component 1510 or some other non-volatile storage component for execution.

In view of the present disclosure, it will be appreciated that various methods and systems have been described according to one or more embodiments for creating and managing virtual shared accounts.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure.

Having thus described embodiments of the disclosure, persons of ordinary skill in the art will recognize that changes may be made in form and detail without departing from the scope of the disclosure. Thus the disclosure is limited only by the claims.

1. A method for a virtual shared account, the method comprising:
setting up an n-member virtual shared account for achieving a goal over a network;
adding members to the virtual shared account; and
contributing funds to the virtual shared account.

2. The method of claim 1, further comprising achieving the goal of the virtual shared account.

3. The method of claim 2, further comprising closing the virtual shared account once the goal is achieved.

4. The method of claim 3, wherein the closing the virtual shared account is done automatically.

5. The method of claim 3, wherein the closing the virtual shared account is done by a designated member of the virtual shared account.

6. The method of claim 1 wherein the setting up further comprises providing a Management Contract setting forth privileges and obligations of the members of the virtual shared account.

7. The method of claim 1 wherein the virtual shared account is set up and used by the members of the virtual shared account through a payment service provider.

8. The method of claim 7 wherein communications between the members of the virtual shared account are done via an application loaded on a website over the network.

9. The method of claim 8 wherein the website further comprises a social networking website.

10. The method of claim 2 wherein the achieving the goal further comprises making a payment to a recipient using the funds of the virtual shared account through a payment service provider.

11. A machine-readable medium comprising a plurality of machine-readable instructions which when executed by one or more processors of a server are adapted to cause the server to perform the method of claim 1.

12. A user device comprising:
one or more processors; and
one or more memories adapted to store a plurality of machine-readable instructions which when executed by the one or more processors are adapted to cause the user device to:
set up an n-member virtual shared account for achieving a goal over a network;
invite members to join the virtual shared account; and
contribute finds to the virtual shared account to achieve the goal of the virtual shared account.

13. The user device of claim 12, wherein the machine-readable instructions when executed by the one or more processors are adapted to display an application loaded on a website for managing communications in connection with setting up and using the virtual shared account.

14. The user device of claim 12, wherein the machine-readable instructions when executed by the one or more processors are adapted to close the virtual shared account when the goal of the virtual shared account is achieved.

15. The user device of claim 12, wherein the machine-readable instructions when executed by the one or more processors are adapted to set up and use the virtual shared account through a payment service provider.

16. The user device of claim 15, wherein the machine-readable instructions when executed by the one or more processors are adapted to cause the user device to pass a user identifier with payment information to a server of the payment service provider.

17. The user device of claim 12, wherein the machine-readable instructions when executed by the one or more processors are adapted for managing the virtual shared account, wherein the managing further comprises editing configuration details of the virtual shared account.

18. The user device of claim 17, wherein the configuration details further comprise a Management Contract set up to govern privileges and obligations of the members of the virtual shared account, the goal of the virtual shared account, and/or a list of the members of the virtual shared account.

19. The user device of claim 12, wherein the machine-readable instructions when executed by the one or more processors are adapted to review and accept other invitations to join other virtual shared accounts.

20. The user device of claim 12 further comprising a wireless telephone, a personal digital assistant (PDA), a personal computer or desktop, a notebook computer, a television set, a game console, or a DVR.

21. A system for setting up and using a virtual shared account, the system comprising:
a payment service provider in communication with at least one user device over a network;
one or more processors; and
one or more memories adapted to store a plurality of machine-readable instructions which when executed by the one or more processors are adapted to cause the system to:
create an n-member virtual shared account for achieving a goal over the network;
add members that join the virtual shared account;
maintain and manage funds of the virtual shared account; and
facilitate payment using the funds of the virtual shared account when the goal of the virtual shared account is achieved.

22. The system of claim 21, wherein the machine-readable instructions when executed by the one or more processors are adapted to cause the system to close the virtual shared account when the goal of the virtual shared account is achieved.

23. The system of claim 21, wherein the machine-readable instructions when executed by the one or more processors are adapted to cause the system to:
receive a user identifier from the at least one user device; and
facilitate the payment amount to a receiver once the goal of the virtual shared account is achieved according to a Management Contract governing the virtual shared account.
